(19) United States
(12) Patent Application Publication
(10) Pub. No.: US 2017/0365028 A1
(43) Pub. Date: Dec. 21, 2017

(54) SHIPPING SUPPORT DEVICE, SHIPPING SUPPORT METHOD, AND COMPUTER-READABLE RECORDING MEDIUM

(71) Applicant: FUJITSU LIMITED, Kawasaki-shi (JP)

(72) Inventor: Sachiko Taguchi, Kawasaki (JP)

(73) Assignee: FUJITSU LIMITED, Kawasaki-shi (JP)

(21) Appl. No.: 15/692,109

(22) Filed: Aug. 31, 2017

Related U.S. Application Data
(63) Continuation of application No. PCT/JP2016/057459, filed on Mar. 9, 2016.

(30) Foreign Application Priority Data
Mar. 9, 2015 (JP) 2015-046461

(51) Int. Cl. G06Q 50/28; G06Q 10/08

(52) U.S. Cl. CPC G06Q 50/28; G06Q 10/087; G06Q 10/0832; H01M 2220/00

(57) ABSTRACT

A computer-readable recording medium storing a shipping support program that causes a computer to execute processing, the processing includes: referencing a first storage section storing item information for each of a plurality of items, the item information including whether or not a battery is contained in the item, and at least one out of a type or shipping state of the battery in cases in which a battery is contained; and in cases in which a result of referencing the item is that an item to be shipped is determined to contain a battery, outputting support information according to at least one out of the type or shipping state of the battery contained in the item to be shipped as identified based on the item information for the item to be shipped.

### CROSS-REFERENCE TO RELATED APPLICATION

This application is a continuation application of International Application No. PCT/JP2016/057459, filed Mar. 9, 2016, the disclosure of which is incorporated herein by reference in its entirety. Further, this application claims priority from Japanese Patent Application No. 2015-046461, filed Mar. 9, 2015, the disclosure of which is incorporated herein by reference in its entirety.

### FIELD

The present disclosure relates to a shipping support device, a shipping support method and a computer-readable recording medium.

### BACKGROUND

When shipping an item, and in particular when shipping an item overseas, a user performing tasks relating to shipping has to carry out procedures according to the shipping destination and according to the item being shipped. As technology to suppress the burden placed on a user, technology exists to support shipping of items. For example, the technology described in Japanese Patent Application Laid-Open (JP-A) No. 2002-137874 is known as technology to support shipping of parts for maintenance, by overseeing supply from centers in neighboring countries in response to a request for a maintenance part for a manufactured product that is in need of maintenance work.

### RELATED PATENT DOCUMENTS

Japanese Laid-Open Patent Publication No. H11-136598

When shipping an item overseas, for example, documentation that needs to accompany the item is set out in advance by laws and other regulations. In cases in which an item contains a battery, the laws and other regulations set out rules regarding the method of packaging, the accompanying documentation, and the like, and these rules are themselves subject to repeated revisions.

### SUMMARY

An aspect is a computer-readable recording medium storing a program that causes a computer to execute processing including the following. The processing includes referencing a first storage section storing item information for each of plural items, the item information including whether or not a battery is contained in the item, and at least one out of a type or shipping state of the battery in cases in which a battery is contained. The processing also includes, in cases in which a result of referencing the item is a determination that an item to be shipped contains a battery, outputting support information according to at least one of the type or shipping state of the battery contained in the item to be shipped, as identified based on the item information for the item to be shipped.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating an example of a schematic functional configuration of a shipping support device of an exemplary embodiment.

FIG. 2 is a diagram to explain a specific example of a product master DB of an exemplary embodiment.

FIG. 3 is a diagram to explain a specific example of a country and operator DB of an exemplary embodiment.

FIG. 4 is a diagram to explain a specific example of an order management DB of an exemplary embodiment.

FIG. 5 is a block diagram illustrating a schematic configuration of a computer that functions as a shipping support device of an exemplary embodiment.

FIG. 6 is a flowchart illustrating an example of invoice generation support processing performed by a shipping support device of an exemplary embodiment.

FIG. 7 is a diagram illustrating a specific example of a display of invoice generation support information output by a shipping support device of an exemplary embodiment.

FIG. 8 is a flowchart illustrating an example of shipping application generation support processing performed by a shipping support device of an exemplary embodiment.

FIG. 9 is a diagram illustrating a specific example of a display of shipping application generation support information output by a shipping support device of an exemplary embodiment.

FIG. 10 is a diagram to explain a specific example of a battery handling DB.

### DESCRIPTION OF EMBODIMENTS

Detailed explanation follows regarding an example of technology disclosed herein, with reference to the drawings.

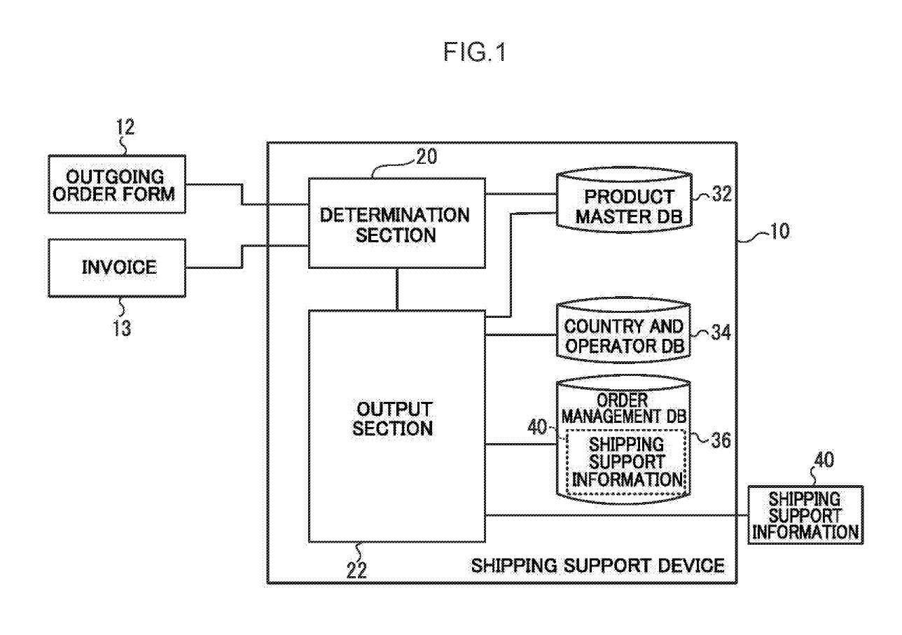

FIG. 1 is a functional block diagram illustrating a schematic functional configuration of an example of a shipping support device 10 of the present exemplary embodiment.

The shipping support device 10 of the present exemplary embodiment provides support to a user performing tasks relating to shipping when shipping (exporting) items overseas.

In general, when shipping items overseas, an invoicing document, known as an invoice, and a shipping order, known as a shipping application, have to be provided to customs officials.

The invoice is a document produced by a sender in the country of export to notify a recipient in the country of import that an item has been dispatched. The invoice includes, for example, the name, type, quantity, value, and payment method for the item, and the addresses, locations, names, and titles of the sender and recipient.

The shipping application is a document giving information used by a customs official to produce an air waybill or the like, and may be in a format stipulated by customs officials.

The transportation of some items is subject to legal restrictions and the like. For example, aviation laws and the United Nations Recommendations on the Transport of Dangerous Goods specify dangerous goods that are subject to strict restrictions on transportation.

Although batteries are not classed as such dangerous goods, rules regarding their transportation are set out by the International Air Transport Association (IATA) and the like. For example, items that are a stand-alone battery, or are an item containing a battery, have to be accompanied by different documentation depending on the battery type and shipping state. Moreover, generally speaking, there are often restrictions applying to the logistics operators that undertake transportation.

The shipping support device 10 of the present exemplary embodiment provides support to a user with tasks relating to shipping products (items) containing batteries. Note that “products containing batteries” in the present exemplary embodiment include cases in which the product is a stand-alone battery.

As illustrated in FIG. 1, the shipping support device 10 of the present exemplary embodiment includes a determination section 20, an output section 22, a product master database (DB) 32, a country and operator DB 34, and an order management DB 36.

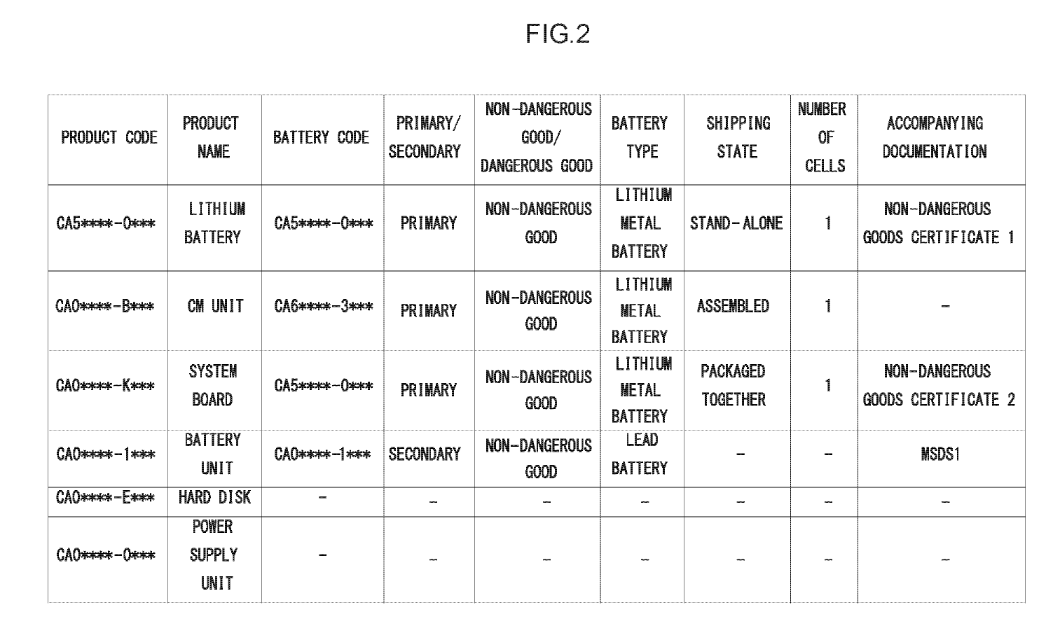

The product master DB 32 is an example of a first storage section of technology disclosed herein, and is stored with item information by product type for each of plural products, including whether or not a battery is contained, and the type and shipping state of the battery in cases in which a battery is contained. FIG. 2 is a diagram to explain a specific example of the product master DB 32 of the present exemplary embodiment.

As illustrated in FIG. 2, as item information, the product master DB 32 of the present exemplary embodiment is stored with information relating to product codes, battery codes, whether the battery is a primary battery or a secondary battery, the battery type, the number of cells, and a battery shipping state. As other information, the product master DB 32 of the present exemplary embodiment is also stored with information relating to product information including product names, whether a product is a dangerous good or non-dangerous good, and accompanying documentation as the item information. The other information need not be stored in the product master DB 32, and may be stored in another DB.

The product codes are codes allocated to each product type and manufactured article. The product name is the product name written on the dispatch invoice and the like when the product is shipped. The battery code is a code allocated to each battery type and manufactured article. The shipping state is the shipping state stipulated for transportation of batteries such as lithium ion batteries and lithium metal batteries under IATA or the like. Specifically, the shipping states include three categories: “stand-alone”; “assembled”; and “packaged together”. The accompanying documentation is documentation that has to accompany the product when transporting the product (particularly in the case of batteries contained in products). The documentation given in FIG. 2 is simplified; however as the accompanying documentation, the product master DB 32 of the present exemplary embodiment is stored with image files of the accompanying documentation (as a specific example, portable document format (pdf) files).

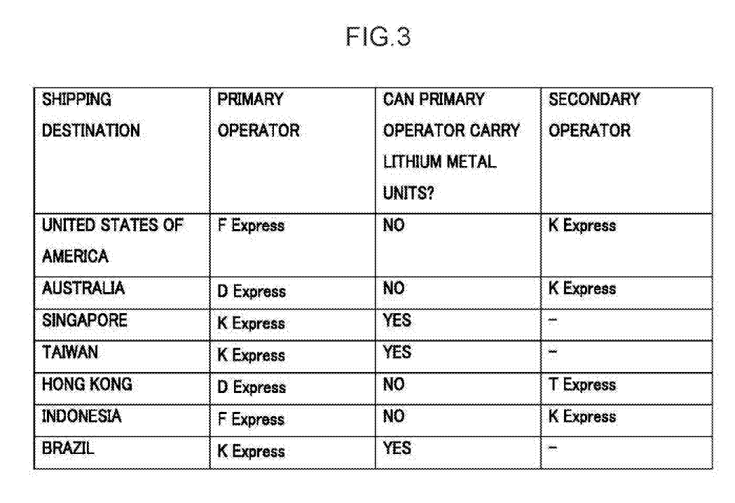

On the other hand, the country and operator DB 34 is stored with shipping destination country information in which countries to be shipped to and logistics operators that transport products to these countries are associated with each other. The country and operator DB 34 is an example of a second storage section of technology disclosed herein. FIG. 3 is a diagram to explain a specific example of the country and operator DB 34 of the present exemplary embodiment.

As illustrated in FIG. 3, as shipping destination country information, the country and operator DB 34 of the present exemplary embodiment is stored with information relating to countries to be shipped to, primary transportation operators, whether or not the primary operators are capable of distributing lithium metal units, and secondary transportation operators.

In the present exemplary embodiment, the country and operator DB 34 is prepared in advance since the logistics operators used vary according to the shipping destination country. Note that amongst batteries, in the present exemplary embodiment, some operators do not undertake transportation of stand-alone lithium metal batteries (such as lithium ion batteries and lithium metal batteries), and thus the secondary operators to be used in cases in which the primary operator will not undertake transportation are included in the shipping destination country information.

The determination section 20 determines whether or not a product contains batteries by acquiring the product code from an outgoing order form 12 of a product order, an invoice 13, or the like, and referencing the product master DB 32.

In cases in which a product contains batteries, the output section 22 references the product master DB 32 and the country and operator DB 34 to select an operator according to the shipping state of the battery, and outputs shipping support information 40 to support product shipping.

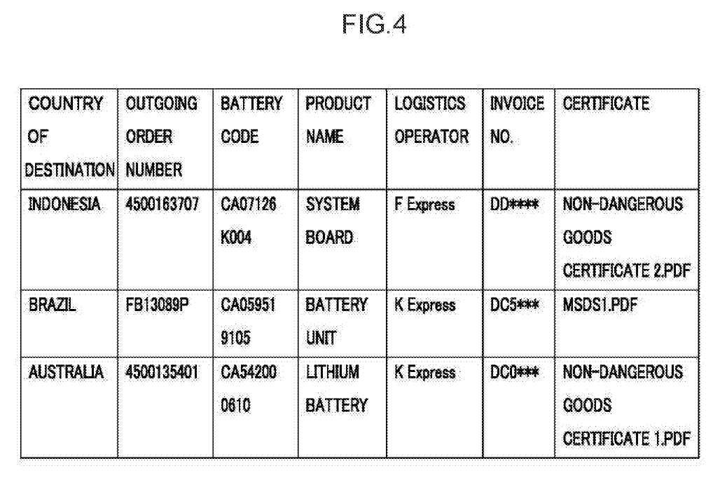

For each outgoing order form 12 (each order), the order management DB 36 is stored with the shipping support information 40 to be used when shipping products according to that outgoing order form 12. FIG. 4 is a diagram to explain a specific example of the order management DB 36 of the present exemplary embodiment.

As illustrated in FIG. 4, as the shipping support information 40, the order management DB 36 of the present exemplary embodiment is stored with information relating to countries of destination, outgoing order numbers, battery codes, product names, logistics operators, invoice numbers (Invoice No.), and certificates.

The country of destination is the country that a product is to be shipped to. The outgoing order number is an outgoing order number that is given to the customer, is written on the outgoing order form, and is an example of “information identifying an item to be shipped” of technology disclosed herein. The invoice number is a number allocated to the invoice accompanying shipment of a product. The certificates are certificates that have to be provided as the accompanying documentation that accompanies the product during shipping. The documentation given in FIG. 4 is simplified; however, similarly to in the product master DB 32, image files of certificates (as a specific example, pdf files) are stored as the certificates.

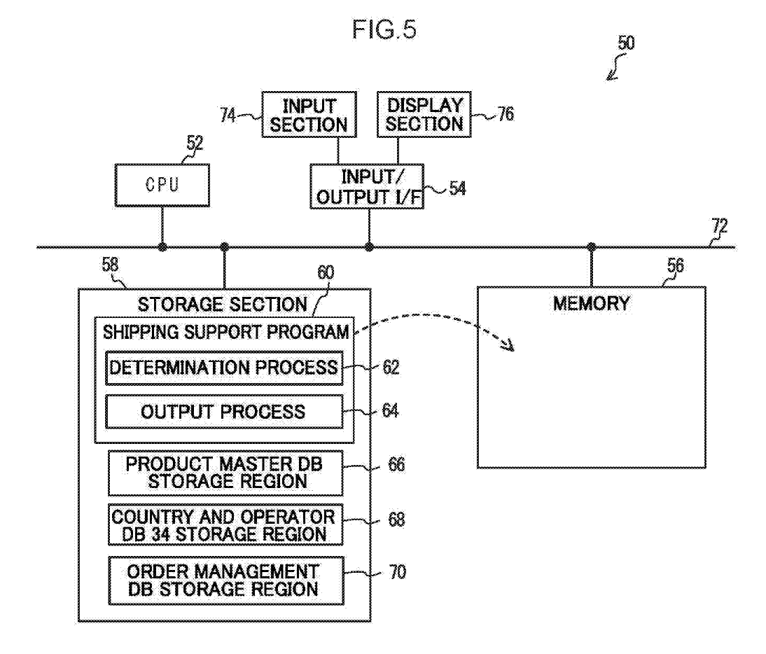

The shipping support device 10 may, for example, be implemented by a computer 50, illustrated in FIG. 5. The computer 50 includes a Central Processing Unit (CPU) 52, an input/output interface (I/F) 54, memory 56, and a non-volatile storage section 58. The CPU 52 the network I/F 54, the memory 56, and the storage section 58 are connected together through a bus 72. The input/output I/F 54 is connected to an input section 74 and a display section 76.

The input section 74 is employed by a user of the shipping support device 10 to input information indicating that points on a checklist have been confirmed, for example. Specific examples of the input section 74 include a touch panel, a microphone, a keyboard, or a mouse.

The display section 76 performs display relating to the shipping support information 40 and the like. Specific examples of the display section 76 of the present exemplary embodiment include a touch panel or a liquid crystal display.

Note that the input section 74 and the display section 76 may be configured by an integral touch panel.

The storage section 58 may be implemented by a Hard Disk Drive (HDD), flash memory, or the like. The storage section 58, serving as a storage medium, is stored with a shipping support program 60 that causes the computer 50 to function as the shipping support device 10. The CPU 52 reads the shipping support program 60 from the storage section 58 and expands the shipping support program 60 into the memory 56, and sequentially executes respective processes included in the shipping support program 60.

The shipping support program 60 includes a determination process 62 and an output process 64.

Moreover, a product master DB storage region 66 of the storage section 58 functions as a storage region stored with the product master DB 32. A country and operator DB storage region 68 of the storage section 58 functions as a storage region stored with the country and operator DB 34. An order management DB storage region 70 of the storage section 58 functions as a storage region stored with the order management DB 36.

The CPU 52 operates as the determination section 20 by executing the determination process 62. The CPU 52 operates as the output section 22 by executing the output process 64.

The computer 50 executing the shipping support program 60 thereby functions as the shipping support device 10.

Note that the computer 50 is not limited to what is known as a desktop-type personal computer. The computer 50 may, for example, be a laptop-type personal computer, or may be a Personal Digital Assistant (PDA), exemplified by tablet terminals and smartphones.

Note that the shipping support device 10 may be implemented by a semiconductor integrated circuit, more specifically an Application Specific Integrated Circuit (ASIC) or the like.

Next, explanation follows regarding operation of the shipping support device 10 according to the present exemplary embodiment.

Explanation follows regarding shipping support processing performed by the shipping support device 10 of the present exemplary embodiment. The shipping support processing of the present exemplary embodiment includes invoice generation support processing to support invoice generation, and shipping application generation support processing to support shipping application generation.

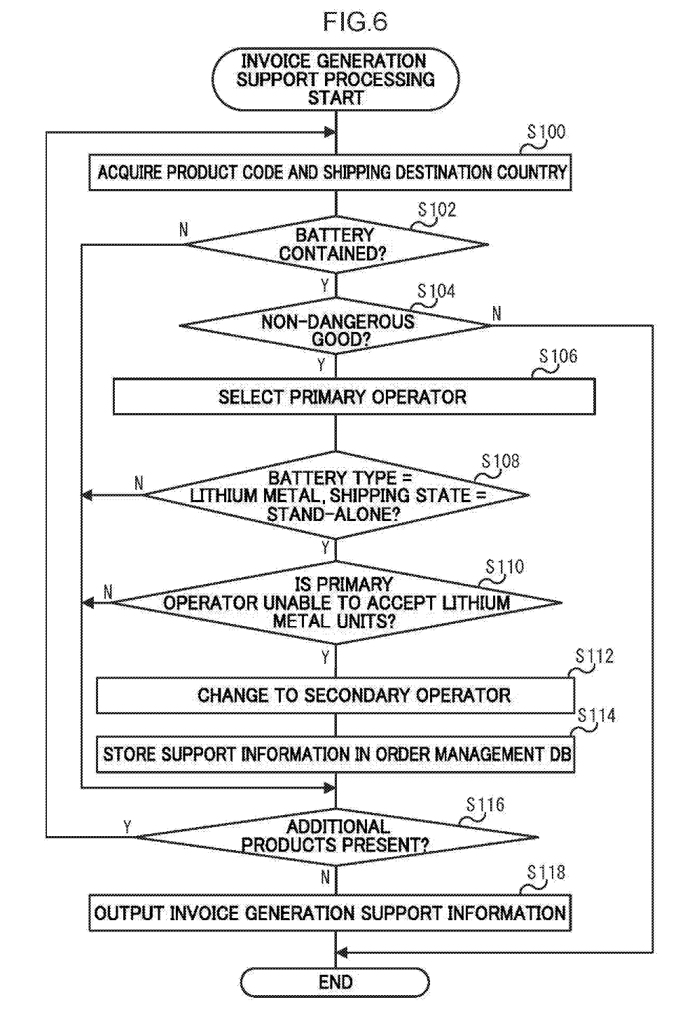

FIG. 6 is a flowchart illustrating an example of the invoice generation support processing performed by the shipping support device 10 of the present exemplary embodiment.

In the shipping support device 10 of the present exemplary embodiment, the invoice generation support processing illustrated in FIG. 6 is executed at a predetermined timing. When an order for a product is received from an overseas customer, the product to be shipped is prepared. Moreover, accompanying documentation is prepared as a shipping procedure (export procedure) that has to be performed in order to ship the product. In the present exemplary embodiment, the invoice generation support processing is executed at a predetermined timing when a user performing tasks relating to shipping carries out shipping procedures.

The invoice generation support processing illustrated in FIG. 6 is executed for each unit of invoice generation, namely for each shipment unit in which products are shipped together.

At step S100, the determination section 20 acquires the product code and shipping destination country for the shipping target product. Note that the method for acquiring the product codes and the shipping destination country are not particularly limited. For example, the acquisition may be made by reading the outgoing order form 12 or an incoming order form, or may be input to the shipping support device 10 by a user.

Next, at step S102, the determination section 20 references the product master DB 32 and determines whether or not the product with the product code acquired at step S100 contains a battery. For example, the product with the product code “CA0****-0***” can be determined not to contain a battery by referencing the product master DB 32 illustrated in FIG. 2. Determination is negative when a battery is not contained, and processing transitions to step S116. On the other hand, for example, the product with the product code “CA5****-0***” can be determined to contain a battery by referencing the product master DB 32 illustrated in FIG. 2. Determination is affirmative when a battery is contained, and processing transitions to step S104.

At step S104, the output section 22 references the product master DB 32, and determines whether or not the battery contained in the product is a non-dangerous good. Determination is negative in cases in which the battery contained in the product is a dangerous good, and the current invoice generation support processing is ended. When the battery contained in the product is a dangerous good, the product needs to be handled individually rather than by normal shipping, and therefore the current invoice generation support processing is ended in the present exemplary embodiment.

On the other hand, determination is affirmative in cases in which the battery contained in the product is not a dangerous good, and processing transitions to step S106.

At step S106, the output section 22 references the country and operator DB 34, and identifies a logistics operator that handles the shipping destination country acquired at step S100. For example, if the shipping destination country is Australia, the output section 22 references the country and operator DB 34 illustrated and FIG. 3 and selects “D Express” as the primary operator.

Next, at step S108, the output section 22 references the product master DB 32, and determines whether or not the battery type is lithium metal, and whether or not the shipping state is stand-alone. The battery type and shipping state stored in the product master DB 32 are referenced, and processing transitions to step S116 in cases in which determination is negative. On the other hand, in cases in which determination is affirmative, processing transitions to step S110.

At step S110, the output section 22 references the country and operator DB 34, and determines whether or not the primary operator accepts stand-alone lithium metal batteries, namely, whether or not the primary operator undertakes transportation of stand-alone lithium metal batteries.

As of Jan. 1, 2015, the transportation of stand-alone lithium metal batteries is generally prohibited on passenger aircraft under IATA and International Civil Aviation Organization (ICAO) regulations. Accordingly, air transportation of stand-alone lithium metal batteries can only be carried out using cargo aircraft, and so some logistics operators and the like that transport using passenger aircraft do not undertake transportation of stand-alone lithium metal batteries. Moreover, in some cases, it is conceivable that air transportation of stand-alone lithium metal batteries may be prohibited entirely. Accordingly, the country and operator DB 34 of the present exemplary embodiment is stored with information relating to logistics operators that do not transport depending on the type and shipping state of batteries contained in products, in accordance with laws, rules, and the like. For example, if the shipping destination country is Australia, by referencing the country and operator DB 34, “D Express”, selected as the primary operator, can be determined to be unable to carry stand-alone lithium metal batteries. In such cases, determination is affirmative at step S110, and processing transitions to step S112.

At step S112, the output section 22 references the country and operator DB 34, and changes the selected logistics operator to the secondary operator, and then processing transitions to step S114.

On the other hand, processing also processing transitions to step S114 in cases in which determination was negative at step S110.

At step S114, the output section 22 stores the information acquired from the product master DB 32, and the logistics operator selected in the processing described above, in the order management DB 36 as the shipping support information 40. Specifically, as the shipping support information 40, the country of destination, battery code, product name, logistics operator, and invoice number are stored associated with the outgoing order number of the outgoing order form 12.

At the next step S116, the output section 22 determines whether or not there are any additional products. Determination is affirmative in cases in which there are products to add to the invoice, and processing returns to step S100, and the current invoice generation support processing is repeated. On the other hand, determination is negative in cases in which there are no additional products, and processing transitions to step S118.

At step S118, the output section 22 outputs invoice generation support information, and then ends the current invoice generation support processing. In cases in which the shipping support device 10 is implemented by the computer 50, for example, the invoice generation support information is displayed on the display section 76.

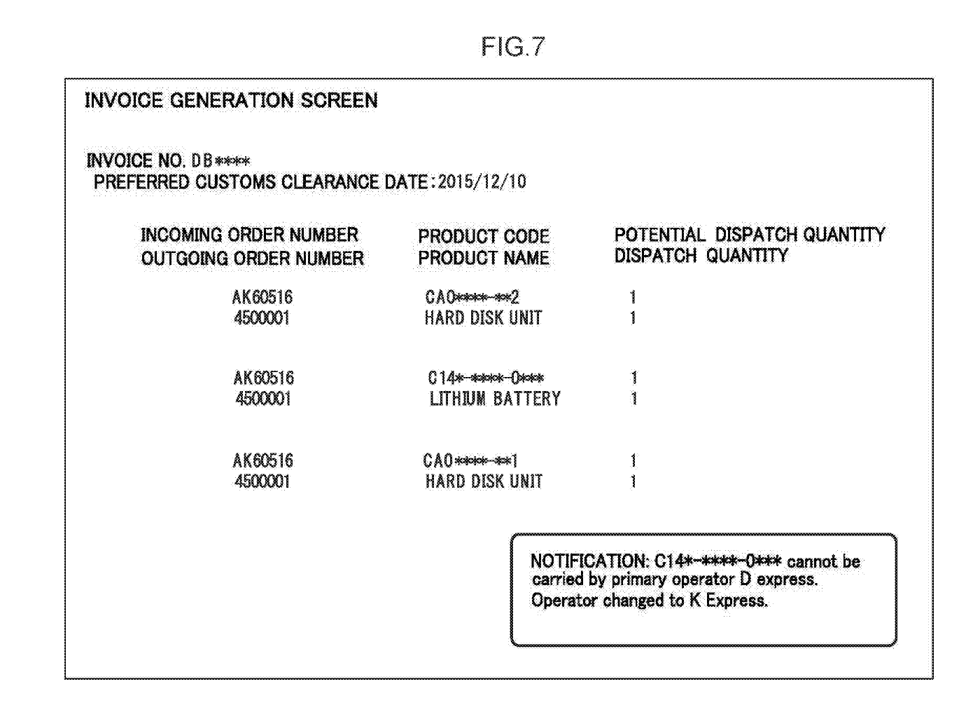

FIG. 7 illustrates a specific example of display of the invoice generation support information output by the shipping support device 10 of the present exemplary embodiment. The specific example illustrated in FIG. 7 represents invoice generation support information to support generation of an invoice with the invoice number “DB****”. Three products are displayed in the specific example illustrated in FIG. 7. In FIG. 7, the “potential dispatch quantity” is the number of items of the product that could be dispatched (shipped) from a warehouse in which they are being stored, and the “dispatch quantity” is the quantity that will actually be dispatched. The “notification” in the specific example illustrated in FIG. 7 notifies of cases in which the selected logistics operator has been changed or the like, as described above. Note that the “notification” may be performed separately.

In this manner, when the invoice generation support information has been output from the shipping support device 10, the user performing tasks relating to shipping then generates an invoice. The user may continue to use the shipping support device 10 to generate the invoice.

When the user has completed invoice generation, next, the user generates a shipping application. The shipping support device 10 of the present exemplary embodiment thus executes the shipping application generation processing.

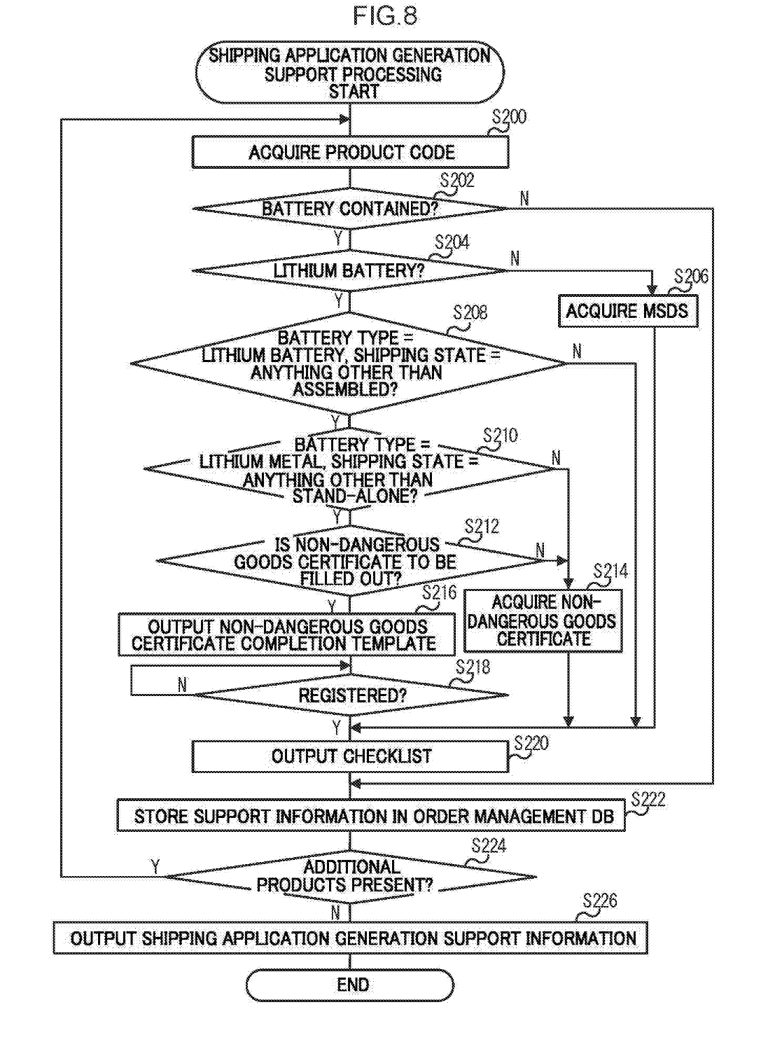

FIG. 8 is a flowchart illustrating an example of the shipping application generation support processing performed by the shipping support device 10 of the present exemplary embodiment.

At step S200, the determination section 20 acquires the product code of the product to be shipped. Note that the method by which the product code is acquired is not particularly limited. For example, this may be performed similarly to step S100 of the invoice generation support processing described above.

Next, at step S202, the determination section 20 references the product master DB 32 to determine whether or not the product with the product code acquired at step S200 contains a battery. Determination is negative in cases in which a battery is not contained, and processing transitions to step S222.

At the next step S204, the output section 22 references the product master DB 32 to determine whether or not the battery type is a lithium battery (lithium ion battery or a lithium metal battery). Determination is negative in cases in which the battery is not a lithium battery, and processing transitions to step S206.

At step S206, the output section 22 acquires a Material Safety Data Sheet (MSDS) as an accompanying document, after which processing transitions to step S220. The MSDS lists the contents, method of handling, transportation method, and the like of the battery. In the present exemplary embodiment, the MSDS is obtained in advance from the battery manufacturer, and is stored in a storage section (not illustrated in the drawings). Specifically, the output section 22 acquires pdf data of the MSDS.

On the other hand, processing transitions to step S208 when determination is affirmative at step S204.

At step S208, the output section 22 determines whether or not the battery type is a lithium battery, and whether the shipping state is anything other than “assembled”. The product master DB 32 is referenced, and processing transitions to step S220 when determination is negative. On the other hand, processing transitions to step S210 when determination is affirmative.

At step S210, the output section 22 determines whether or not the battery type is lithium metal, and whether or not the shipping state is anything other than stand-alone. The product master DB 32 is referenced, and processing transitions to step S214 when determination is negative.

At step S214, the output section 22 acquires a non-dangerous goods certificate as an accompanying document, after which processing transitions to step S220. In the present exemplary embodiment, a non-dangerous goods certificate issued by the company itself is stored in a storage section (not illustrated in the drawings) in advance. Specifically, the output section 22 acquires pdf data of the non-dangerous goods certificate.

On the other hand, processing transitions to step S212 when determination is affirmative at step S210.

At step S212, the output section 22 determines whether or not the user is to fill out a non-dangerous goods certificate. Sometimes, depending on the logistics operator used, the battery type, or the like, the user fills out a non-dangerous goods certificate rather than using the pre-stored non-dangerous goods certificate mentioned above. Accordingly, at the present step, determination is made as to whether or not the user is to fill out a non-dangerous goods certificate. Note that the determination method is not particularly limited, and, for example, information to the effect that a non-dangerous goods certificate is to be filled out may be stored in the product master DB 32.

Processing transitions to step S214 when determination is negative at step S212. On the other hand, processing transitions to step S216 when determination is affirmative at step S212.

At step S216, the output section 22 outputs a non-dangerous goods certificate template. For example, the output section 22 outputs non-dangerous goods certificate template data to an external printer, and the non-dangerous goods certificate template is printed by the external printer. After the user has filled in the applicable sections of the non-dangerous goods certificate template, the completed non-dangerous goods certificate is uploaded and registered in the shipping support device 10.

Then, at step S218, the output section 22 determines whether or not the non-dangerous goods certificate has been registered, and makes negative determination and adopts a standby state until registration has been performed. On the other hand, when registration has been performed, determination is affirmative, and processing transitions to step S220.

At step S220, the output section 22 outputs a checklist. Specifically, the output section 22 displays a checklist screen or the like. The checklist displays the accompanying documentation mentioned above and the like. The user confirms the displayed checklist, and inputs information indicating that confirmation has been made. Specifically, the user operates a confirmation button (not illustrated in the drawings) or the like provided to the shipping support device 10 to input information indicating that confirmation has been made. Note that in cases in which an error is present in the points confirmed by the user, the current shipping application generation support processing may be ended, and the user may, for example, prepare the accompanying documentation separately.

When the information indicating that confirmation has been made has been input by the user, processing transitions to step S222.

At step S222, the output section 22 stores accompanying documentation data in the order management DB 36 as the shipping support information 40. Specifically, as the shipping support information 40, the output section 22 stores pdf data of the accompanying documentation associated with the outgoing order number of the outgoing order form 12.

At the next step S224, the output section 22 determines whether or not there are any additional products. In cases in which there is a product to add to the shipping application, determination is affirmative, processing returns to step S200, and the current shipping application generation support processing is repeated. On the other hand, when there are no additional products, determination is negative and processing transitions to step S226.

At step S226, the output section 22 outputs shipping application generation support information, and then ends the current shipping application generation support processing. For example, in cases in which the shipping support device 10 is implemented by the computer 50, the shipping application generation support information is displayed on the display section 76.

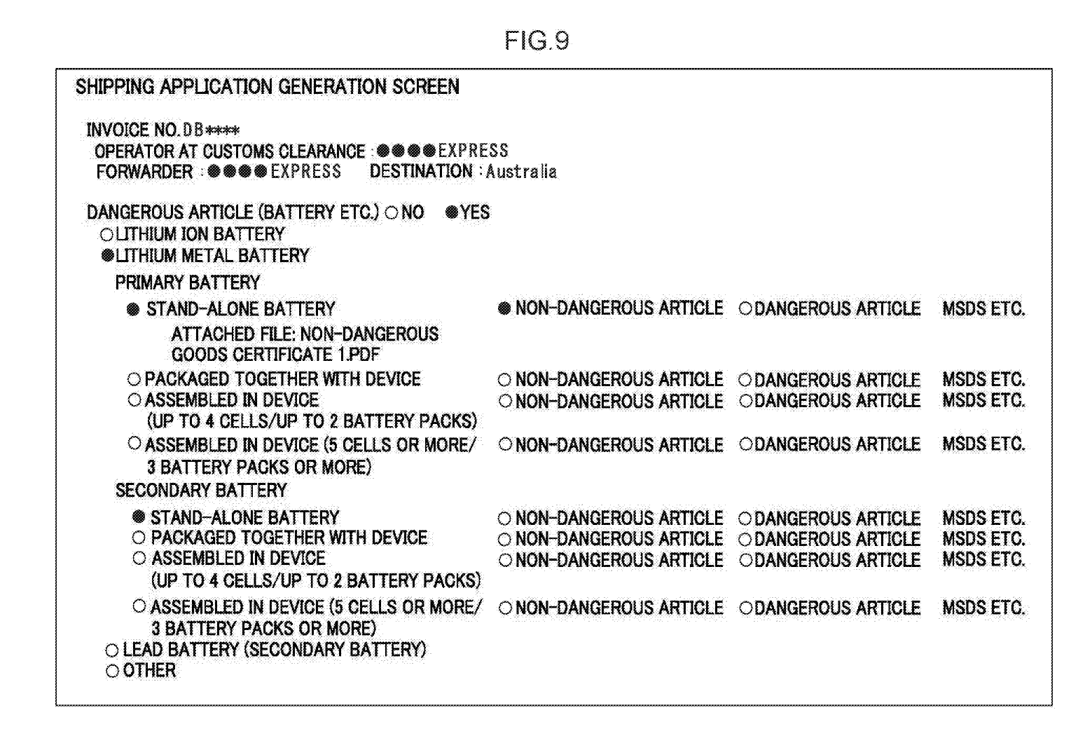

FIG. 9 illustrates a specific example of display of the shipping application generation support information output by the shipping support device 10 of the present exemplary embodiment. The specific example illustrated in FIG. 9 represents shipping application generation support information to support generation of a shipping application for the invoice number “DB****”. The specific example illustrated in FIG. 9 illustrates a state in which information has been set up for batteries in products corresponding to the invoice number “DB****”.

In this manner, when the shipping application generation support information has been output from the shipping support device 10, next, the user performing tasks relating to shipping generates the shipping application. The user may continue to use the shipping support device 10 to generate the shipping application.

In this manner, the shipping support device 10 completes invoice and shipping application generation, and the shipping support information 40 is in a state stored in the order management DB 36. Then, when the user performing tasks relating to shipping receives a product shipment instruction, the user is able to reference the shipping support information 40 and attach the applicable accompanying documentation to the product, based on the outgoing order number or the like. The user is also able to confirm the logistics operator that will undertake transportation of the product.

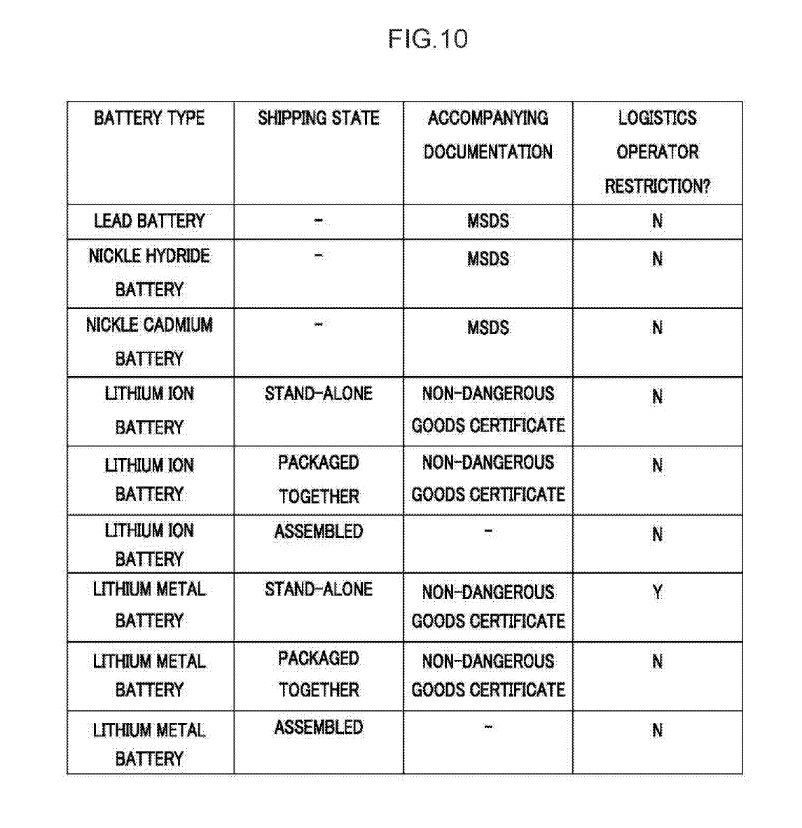

Note that the processing of steps S204 to S218 is processing in order to attach the applicable documentation when transporting batteries contained in products to be shipped. This processing is processing performed based on rules set out by laws and the like, and obviously, when regulations result in a change to the accompanying documentation, the processing is also changed in line with such changes. Moreover, in this processing, a battery handling DB in which battery types, shipping states, and accompanying documentation are stored associated with one another may be provided to the shipping support device 10 in advance, and this battery handling DB may be referenced. FIG. 10 is a drawing to explain a specific example of a battery handling DB of the present exemplary embodiment.

The specific example illustrated in FIG. 10 illustrates a case in which information relating to restrictions on logistics operators (information relating to logistics operators that will not undertake transportation) is also associated and stored as information relating to batteries. It is more preferable to configure a separate DB such as the battery handling DB than it is to store information relating to the accompanying documentation associated with the product codes with the accompanying documentation in the product master DB 32. By configuring a separate DB, when there are changes to rules set out by laws and the like, it is sufficient to change only this separate DB in line with the rules, thus reducing the effort involved in making changes.

As described above, the shipping support device 10 of the present exemplary embodiment includes the product master DB 32 stored with item information including whether or not a battery is contained, and at least one out of the type and shipping state of the battery in cases in which a battery is contained. The shipping support device 10 also includes the country and operator DB 34 stored with the shipping destination country information, including information relating to shipping destination countries and the logistics operators who transport products to the shipping destination countries. The shipping support device 10 references the product master DB 32, and the determination section determines whether or not a battery is contained in a product to be shipped. Moreover, in cases in which a result of referencing an item, the product has been determined to contain a battery, the output section 22 references the product master DB 32 and outputs the shipping support information 40 according to at least one of the battery type or the shipping state.

The shipping support device 10 of the present exemplary embodiment facilitates generation of an invoice and a shipping application. Moreover, the shipping support device 10 enables accompanying documentation to be prepared with ease, based on the support information when shipping a product.

Accordingly, the shipping support device 10 of the present exemplary embodiment enables the burden placed on a user performing tasks relating to shipping products containing batteries to be alleviated.

Note that the shipping support information 40 is not limited by the exemplary embodiment described above. It is sufficient that the information relates to rules set out by laws and the like relating to the transportation of batteries. For example, there are rules demanding that lithium battery handling labels be affixed to the product packaging when transporting lithium batteries, and so information relating to handling labels (for example information regarding whether or not this has been affixed, or notification directed at the product warehouse) may be included in the shipping support information 40.

Moreover, the details of the shipping support processing explained in the exemplary embodiment described above may obviously be changed as appropriate according to the rules set out by laws and the like relating to battery transportation.

Moreover, the shipping support processing performed by the shipping support device 10 may obviously be applied both to cases in which the product is to be carried by aircraft, and cases in which the product is to be carried by ship.

Moreover, in the exemplary embodiment described above, explanation has been given regarding a state in which the product master DB 32 and the country and operator DB 34 are stored within the shipping support device 10. However, the storage location of the product master DB 32 and the country and operator DB 34 is not limited to within the shipping support device 10. For example, at least one of the product master DB 32 or the country and operator DB 34 may be stored in an external device (external server) or the like. Moreover, similarly, the order management DB 36 may be stored on an external device rather than being stored within the shipping support device 10.

Note that in the exemplary embodiment described above, explanation has been given regarding a configuration in which the shipping support program 60 is in stored in advance (installed) in the storage section 58. However, the shipping support program 60 may be provided in a format recorded on a recording medium. Recording media include, for example, Compact Disk Read Only Memory (CD-ROM), Digital Versatile Disk Read Only Memory (DVD-ROM), Universal Serial Bus (USB) memory, and the like.

When an item to be shipped includes a battery, the burden placed on a user performing tasks relating to shipping is greater than when shipping other items, and there is an issue in that human error is liable to occur.

An aspect of the present disclosure has the advantageous effect of enabling the burden on a user performing tasks relating to shipping items containing batteries to be alleviated.

All cited documents, patent applications, and technical standards mentioned in the present specification are incorporated by reference in the present specification to the same extent as if each individual cited document, patent application, or technical standard was specifically and individually indicated to be incorporated by reference.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a shipping support program that causes a computer to execute processing, the processing comprising:
referencing a first memory storing item information for each of a plurality of items, the item information including whether or not a battery is contained in the item, and at least one of a type or shipping state of the battery in cases in which a battery is contained; and
in cases in which a result of referencing the item is a determination that an item to be shipped contains a battery, outputting support information according to at least one of the type or shipping state of the battery contained in the item to be shipped, as identified based on the item information for the item to be shipped.

2. The computer-readable recording medium of claim 1, wherein the support information is stored in the first memory in association with information identifying the item to be shipped.

3. The computer-readable recording medium of claim 1, wherein:
the item information includes information relating to applicable accompanying documentation according to a type of battery contained in an item or a shipping state of the battery; and
the support information includes information relating to the accompanying documentation.

4. The computer-readable recording medium of claim 1, further comprising:
referencing a second memory storing shipping destination country information including a shipping destination country and information relating to an operator to transport the item to the shipping destination country; and
the support information includes information relating to the operator, according to the shipping destination country of the item to be shipped.

5. The computer-readable recording medium of claim 4, wherein the shipping destination country information further includes at least one of a type or the shipping state of battery that the operator is unable to transport, and includes an alternative operator.

6. The computer-readable recording medium of claim 1, wherein the support information is information to support generation of at least one of an invoice or a shipping application.

7. A shipping support device comprising:
a first memory; and
a processor coupled to the first memory and configured to execute a process including:
referencing the first memory storing item information for each of a plurality of items, the item information including whether or not a battery is contained in the item, and at least one of a type or shipping state of the battery in cases in which a battery is contained, indicating whether or not an item to be shipped contains a battery; and
in cases in which a result of referencing the item is a determination that the item to be shipped contains a battery, outputting support information according to at least one of the type or shipping state of the battery contained in the item to be shipped, as identified based on the item information for the item to be shipped.

8. The shipping support device of claim 7, wherein the support information is stored in the first memory in association with information identifying the item to be shipped.

9. The shipping support device of claim 7, wherein:
the item information includes information relating to applicable accompanying documentation according to a type of battery contained in an item or a shipping state of the battery; and
the support information includes information relating to the accompanying documentation.

10. The shipping support device of claim 7, further comprising a second memory, wherein:
the processing further includes referencing the second memory, which stores shipping destination country information including a shipping destination country and information relating to an operator to transport the item to the shipping destination country; and
the support information includes information relating to the operator, according to the shipping destination country of the item to be shipped.

11. The shipping support device of claim 10, wherein the shipping destination country information further includes at least one of a type or the shipping state of the battery that the operator is unable to transport, and includes an alternative operator.

12. The shipping support device of claim 7, wherein the support information is information to support generation of at least one out of an invoice or a shipping application.

13. A shipping support method that causes a computer to execute a processing, the processing comprising:
by a processor:
referencing a first memory storing item information for each of a plurality of items, the item information including whether or not a battery is contained in the item, and at least one of a type or shipping state of the battery in cases in which a battery is contained; and
in cases in which a result of referencing the item is a determination that an item to be shipped contains a battery, outputting support information according to at least one of the type or shipping state of the battery contained in the item to be shipped, as identified based on the item information for the item to be shipped.

14. The shipping support method of claim 13, wherein the support information is stored in the first memory in association with information identifying the item to be shipped.

15. The shipping support method of claim 13, wherein:
the item information includes information relating to applicable accompanying documentation according to a type of battery contained in an item or a shipping state of the battery; and
the support information includes information relating to the accompanying documentation.

16. The shipping support method of claim 13, further comprising:
referencing a second memory storing shipping destination country information including a shipping destination country and information relating to an operator to transport the item to the shipping destination country; and
the support information includes information relating to the operator according to the shipping destination country of the item to be shipped.

17. The shipping support method of claim 16, wherein the shipping destination country information further includes at least one of a type or the shipping state of the battery that the operator is unable to transport, and includes an alternative operator.

18. The shipping support method of claim 13, wherein the support information is information to support generation of at least one of an invoice or a shipping application.
